(19) United States
(12) Patent Application Publication
(10) Pub. No.: US 2023/0358095 A1
(43) Pub. Date: Nov. 9, 2023

(54) Radio Frequency Shielded Door System

(71) Applicant: Stefan Joseph Hipskind, Broken Arrow, OK (US)

(72) Inventor: Stefan Joseph Hipskind, Broken Arrow, OK (US)

(21) Appl. No.: 18/313,970

(22) Filed: May 8, 2023

Related U.S. Application Data
(60) Provisional application No. 63/339,344, filed on May 6, 2022.

(51) Int. Cl. E06B 7/23; E06B 5/18

(52) U.S. Cl. CPC E06B 7/2318; E06B 5/18

(57) ABSTRACT

A radio frequency shielding door system comprising a door, a frame, and a plurality of sealing mechanisms. The door is situated within and perimetrically surrounded by the frame with the plurality of sealing mechanisms arranged between the door and the frame. The plurality of sealing mechanisms further comprise a first U-channel, a second U-channel, and an inflatable seal. The second U-channel is slidingly engaged with the first U-channel and the inflatable seal is arranged between the first U-channel and the second U-channel. When activated, the second U-channel slides relative to the first U-channel, filling the space between the door and the frame while the inflatable seal provides additional sealing between the first and second U-channels.

### FIELD OF THE INVENTION

The present invention relates generally to radio frequency shielding, and particularly to radio frequency shielded sealing on RF doors.

### BACKGROUND OF THE INVENTION

Radio Frequencies are common in communication devices such as computers, televisions, mobile phones, etc. Additionally, radio frequency energy is used in the form of electromagnetic waves for medical applications. One specific use of radio frequency energy is to generate images of the human body in magnetic resonance imaging (MRI).

Electromagnetic waves can be shielded by placing conductive material in their path. This shielding ability is dependent on the type, thickness, permeability, and other factors. Certain materials work better for shielding different types of electromagnetic waves. For radio waves, there are a variety of acceptable materials for shielding, including steel and copper.

Facilities with significant radio waves may require shielding to protect the surrounding people and equipment. MRIs are highly acceptable to outside Radio Frequency (RF) interference. In order for an MRI to perform properly, these must be kept RF free from outside RF interference outside of the MRI exam room. This is done by a RF enclosure, including a RF door.

Any RF shielded enclosure is only as good as its lowest performance area. The RF Door is the only moving item in an enclosure and thus typically is the area of lowest RF performance. Current RF doors use multiple methods to obtain the required RF performance to seal the joint around the door and door frame. These methods are friction wedge fits and mesh gasket inflatable seals. However, these individual methods have inherit flaws: high maintenance, threshold bumps/ramps, high open/close force requirements, excessive opening time, overall appearance of non-standard door hardware. These doors make it difficult to access the room due to excessive opening time as well as a lip/bump that impedes the movement of carts, machinery, wheelchairs, etc.

The above limitations of current technology demonstrate the need for a RF sealing system shielding door that allows for efficient (timely) and barrier-free access while still maintaining effectively shielding against electromagnetic radiation.

### SUMMARY OF THE INVENTION

The present invention is a radio frequency shielding door comprising a door, a frame, a plurality of sealing mechanisms, and a pneumatic limit switch. The sealing mechanisms each further comprise a first U-channel, a second U-channel, at least one pneumatic cylinder, and at least one inflatable seal.

In use, the present invention is activated by the pneumatic limit switch. When activated, the pneumatic cylinders press the sliding panels between the frame and the door on all sides and seal the U-channels against one another and against the sliding panel to create a first RF seal. The inflatable seals may simultaneously activate to fill in any remaining gaps between the door and the frame, creating a second RF seal. This type of Dual RF Sealing system can be used on hinged (MM for example) swinging doors as well as sliding (pocket) door. The Dual RF Shielding system can accommodate almost any size RF door requirement.

### BRIEF DESCRIPTION OF THE DRAWINGS

FIG. 1 is a top front perspective view of the present invention in accordance with at least one embodiment.

FIG. 2 is a top rear perspective view of the present invention in accordance with at least one embodiment.

FIG. 3 is a front elevation view of the present invention in accordance with at least one embodiment.

FIG. 4 is a rear elevation view of the present invention in accordance with at least one embodiment.

FIG. 5 is a right-side elevation view of the present invention in accordance with at least one embodiment.

FIG. 6 is a left-side section view of the present invention in accordance with at least one embodiment.

FIG. 7 is a top section view of the present invention in accordance with at least one embodiment.

FIG. 8 is an isometric view of one of the plurality of sealing mechanisms in a disengaged configuration in accordance with at least one embodiment.

FIG. 9 is a side elevation view of one of the plurality of sealing mechanisms in a disengaged configuration in accordance with at least one embodiment.

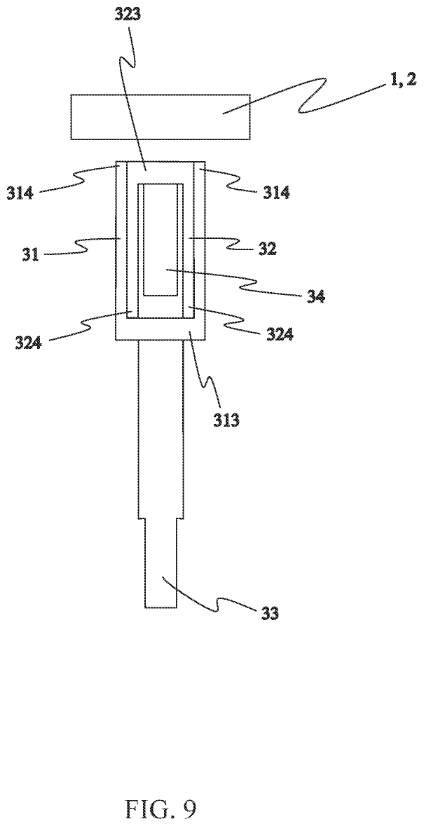

FIG. 10 is an isometric view of one of the plurality of sealing mechanisms in an engaged configuration in accordance with at least one embodiment.

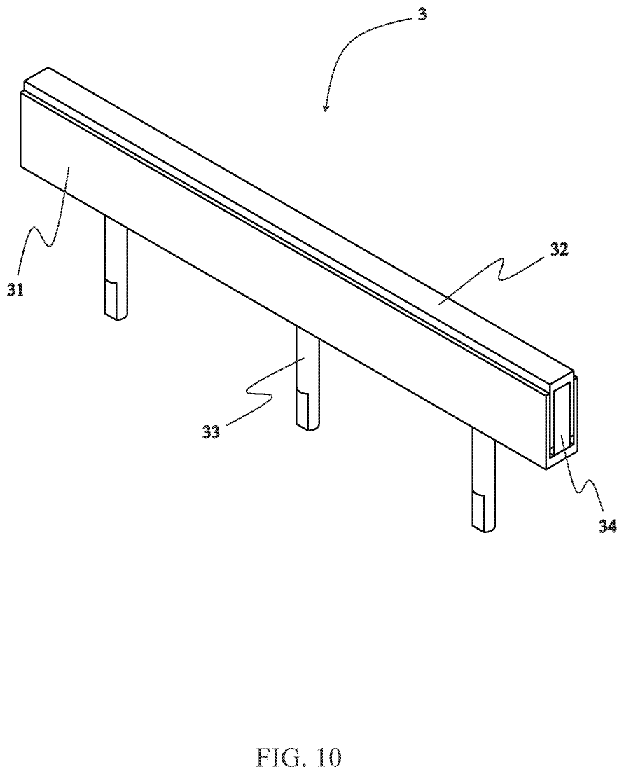

FIG. 11 is a side elevation view of one of the plurality of sealing mechanisms in an engaged configuration in accordance with at least one embodiment.

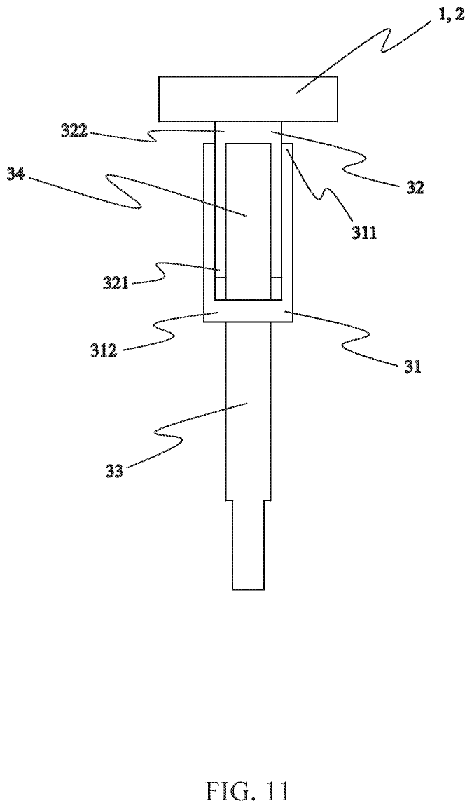

FIG. 12 is an exploded top front perspective view of the present invention in accordance with at least one embodiment.

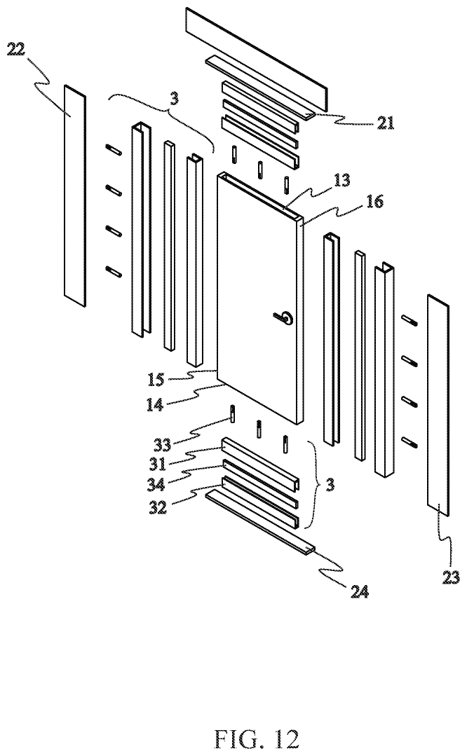

FIG. 13 is an illustration of one of the plurality of sealing mechanisms of the present invention in accordance with at least one embodiment.

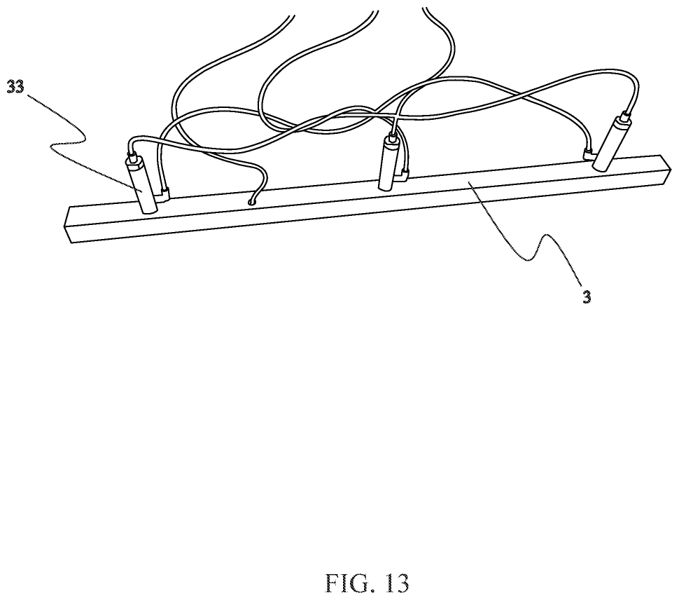

### DETAIL DESCRIPTIONS OF THE INVENTION

All illustrations of the drawings are for the purpose of describing selected versions of the present invention and are not intended to limit the scope of the present invention.

The present invention is a RF dual seal radio frequency shielding door comprising a door 1, a frame 2, a plurality of sealing mechanisms 3, and a pneumatic limit switch 4.

The door 1 of the present invention is the standard shape of a door, having a front side 11, a rear side 12, a top side 13, a bottom side 14, a hinge side 15, and a latch side 16. The frame of the present invention comprises a top frame 21, a hinge frame 22, a latch frame 23, and a threshold frame 24. In many embodiments, the threshold frame 24 is the RF floor of the enclosure in which the invention is used. The door 1 is arranged within the frame 2 and perimetrically surrounded by the frame 2. The door 1 and frame 2 of the present invention are preferably constructed of steel or another radio frequency shielding material in order to effectively shield radio waves. Some structural and/or ornamental components of the frame 2 and door 1 need not be made of a shielding material.

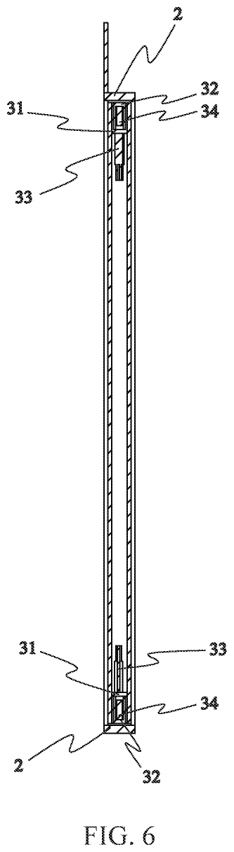

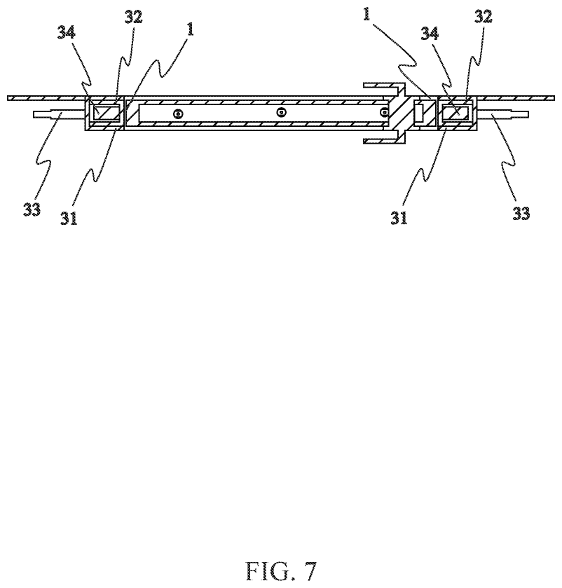

As shown in FIG. 6-7, each of the plurality of sealing mechanisms 3 of the present invention comprises a first U-channel 31, a second U-channel 32, at least one pneumatic cylinder 33, and at least one inflatable seal 34. The present invention uses both pneumatic cylinders and inflatable seals to ensure a complete RF seal for maximum shielding effectiveness. The first U-channel 31 comprises a first open end 311 and a first closed end 312 and the second U-channel 32 comprises a second open end 321 and a second closed end 322. In the preferred embodiment, the first U-channel 31 is comprised of a first base 313 at the first closed end 312 with a first pair of prongs 314 extending from the first base 313, parallel to each other, terminating in the first open end 311. Similarly, the second U-channel 32 is comprised of a second base 323 at the second closed end 322 with a second pair of prongs 324 extending from the second base 323, parallel to each other, terminating in the second open end 321. The shape and size of the U-channels allows the second open end 321 to fit inside the first open end 311 and the at least one inflatable seal 34 to fit inside the second open end 321. Specifically, a first width distance is delineated at the first open end 311 and a second width distance is delineated at the second open end 321 with the second width distance being smaller than the first width distance. The first U-channel 31 and the second U-channel 32 are oppositely oriented with the first open end 311 facing the opposite direction of the second open end 321. This orientation positions the first closed end 312 and the second closed end 322 positioned opposite each other about the first open end 311 and the second open end 321. The second U-channel 32 is configured to slidingly engage with the first open end 311 of the first U-channel 31. In the preferred embodiment, the second U-channel 32 and first U-channel 31 connect to create an enclosed space surrounding the at least one inflatable seal 34, the first pair of prongs 314 in contact with the second pair of prongs 324 and the at least one pneumatic cylinder 33 arranged between the closed end of the first U-channel 31 at the closed end of the first U-channel 31. The at least one pneumatic cylinder 33 is operatively connected to the first U-channel 31 and/or the second U-channel 32 and configured to move the second U-channel 32 relative to the first U-channel 31 when activated. The at least one inflatable seal 34 may be arranged between the first U-channel 31 and the second U-channel 32 inside the second U-channel 32 and/or within the open end of the first U-channel 31. The at least one inflatable seal 34 is configured to expand, creating a more secure contact between the first U-channel 31 and the second U-channel 32 to fill any gaps left between components. This combination of sliding sealing from the at least one pneumatic cylinder 33 and inflating sealing from the at least one inflatable seal 34 creates the dual radio frequency seal of the present invention. The at least one inflatable seal 34 may be expanded by filling with air or gas, but the at least one inflatable seal may instead be an expansion material or any apparatus that expands, inflates, or otherwise increases in size to fill the space between the first U-channel 31 and the second U-channel 32, creating more secure contact and filling in gaps.

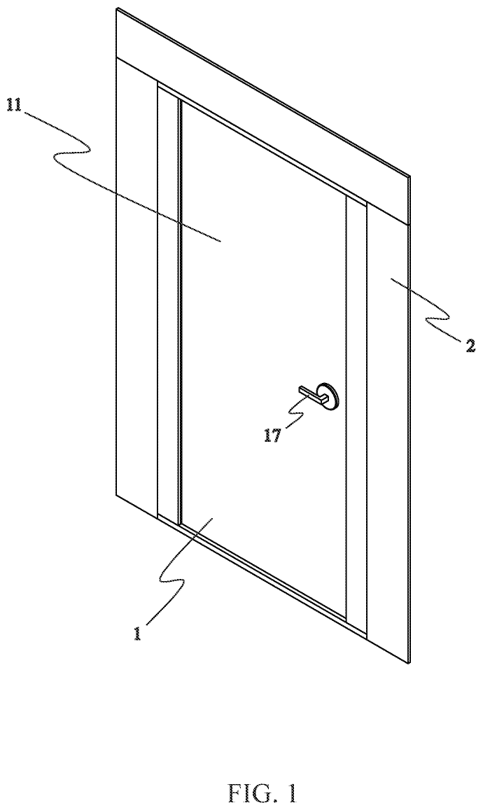

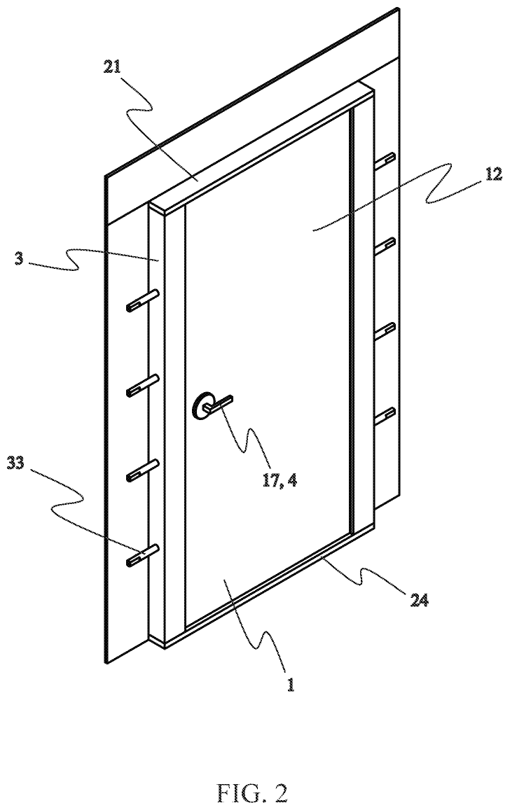

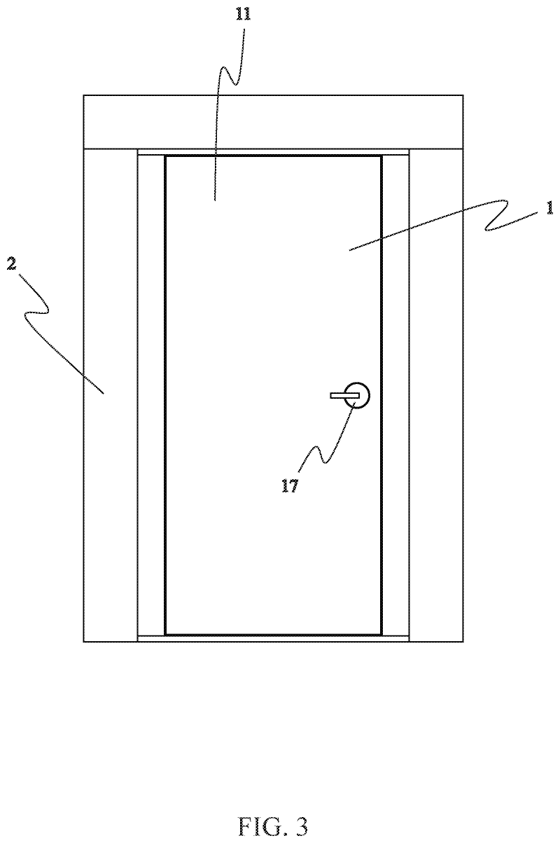

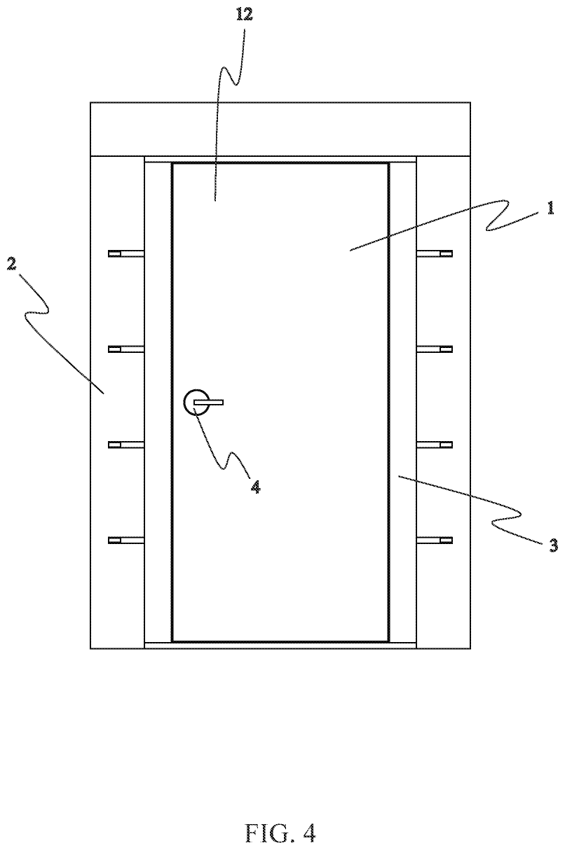

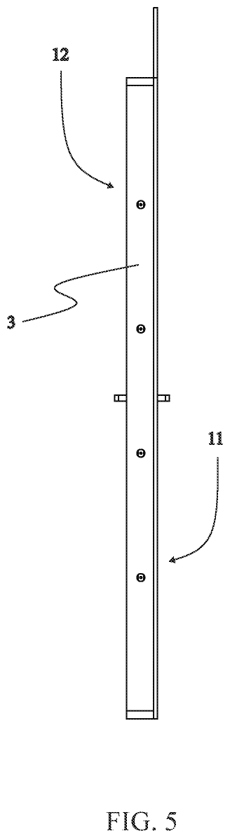

As shown in FIG. 1-5, one of the plurality of sealing mechanisms 3 is used to connect the door 1 to the frame 2 on each side of the door 1 and frame 2. The top side 13 of the door 1 is sealed to the top frame 21 with one of the plurality of sealing mechanisms 3. The bottom side 14 of the door 1 is sealed to the threshold frame 24 with one of the plurality of sealing mechanisms 3. The hinge side 15 of the door 1 is sealed to the hinge frame 22 with one of the plurality of sealing mechanisms 3. And finally, the latch side 16 of the door 1 is sealed to the latch frame 23 with one of the plurality of sealing mechanisms 3. The sealing mechanism of the plurality of sealing mechanisms 3 that is used for a given side may be housed within the door 1 and extend the second U-channel 32 toward the frame 2 in some embodiments or may be housed within the frame 2 and extend the second U-channel 32 toward the door 1 in some embodiments. Some embodiments may use a combination of orientations for the plurality of sealing mechanisms 3. For example, in the preferred embodiment, one of the plurality of sealing mechanisms 3 is housed within the top side 13 of the door 1, one of the plurality of sealing mechanisms 3 is housed within the bottom side 14 of the door 1, one of the plurality of sealing mechanisms 3 is housed within the latch frame 23, and one of the plurality of sealing mechanisms 3 is housed within the hinge frame 22. In sealing the frame 2 to the door 1 with the plurality of sealing mechanisms 3, the second base 323 is pressed against the respective door 1 or frame 2. Each of the plurality of sealing mechanisms 3 has an engaged configuration and a disengaged configuration. In the disengaged configuration, the second U-channel 32 is fully engaged with the first U-channel 31, positioned within the first open end 311. The second closed end 322 of the second U-channel 32 is positioned away from the frame or door 1 in the disengaged configuration with the second open end 321 positioned adjacent to the first closed end 312 and the first pair of prongs 314 fully overlapping the second pair of prongs 324. In the engaged configuration, the second U-channel 32 is partially engaged with the first U-channel 31, positioned within the first open end 311. The second closed end 322 of the second U-channel 32 is positioned against the frame 2 or door 1 in the engaged configuration with the second open end 321 positioned away from the first closed end 312 and the first pair of prongs 314 partially overlapping the second pair of prongs 324. In the disengaged configuration, the at least one inflatable seal 34 is uninflated. In the engaged configuration, the at least one inflatable seal 34 is inflated, filling the space between the first U-channel 31 and the second U-channel 32.

The preferred embodiment includes one of the plurality of sealing mechanisms 3 in the bottom side 14 of the door 1 to ensure that the threshold frame 24 does not need a lip or elevated surface above the ground. This makes the threshold ADA compliant and more accessible for wheeled equipment and reduces the risk of tripping over an elevated lip while passing through the door 1 way. In some embodiments, the threshold frame 24 may simply be the floor, or may be a thin piece of a material that creates an acceptable seal with the sliding panel.

When activated, for one of the plurality of sealing mechanisms 3 housed within the door 1, the at least one pneumatic cylinder 33 presses the second U-channel 32 against the frame 2 and the at least one inflatable seal 34 simultaneously activates to provide dual shielding by enhancing the seal between the first U-channel 31 and the second U-channel 32. For one of the plurality of sealing mechanisms 3 housed within the frame 2, the same activation occurs, but the sliding panel is pressed from the frame against the door 1.

The pneumatic limit switch 4 is a component in pneumatic connection with the at least one pneumatic cylinder 33 and the at least one inflatable seal 34 for each of the plurality of sealing mechanisms 3. The pneumatic limit switch 4 is configured to activate and deactivate the plurality of sealing mechanisms 3. In the preferred embodiment, one of the pneumatic limit switches 4 is a handle 17 latch for the door 1. In this embodiment, the plurality of sealing mechanisms 3 is activated when the door 1 closes and pushes against the frame. The plurality of sealing mechanisms 3 then deactivates when the handle 17 is turned and unlatched from the frame. This embodiment of the pneumatic limit switch 4 being the handle 17 of the door 1 allows for fast and automatic sealing and unsealing through a process already inherent to opening and closing a door 1. In other embodiments, instead of the pneumatic limit switch 4 being integrated into the handle 17 of the door 1, the pneumatic limit switch 4 may be integrated into other mechanical components such as a hinge or latch on the door 1, a latch on the frame 2, or even a button external to the door 1 and frame 2.

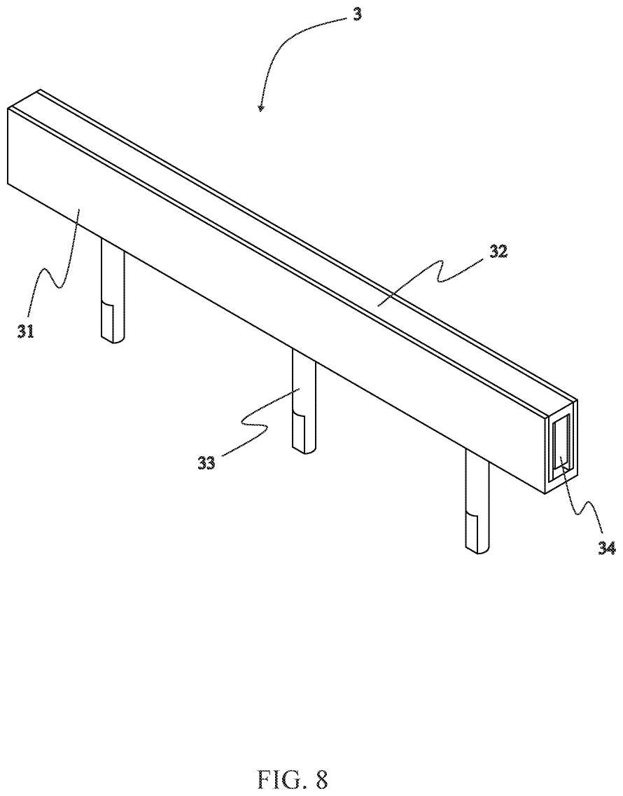

Referring to FIG. 8, the at least one pneumatic cylinder 33 and the at least one inflatable seal 34 of the each of the plurality of sealing mechanisms 3 may be connected by tubing to a pneumatic source or may be self-contained and individually activatable.

In the preferred embodiment, the hinge side 15 of the door 1 is attached to the hinge frame 22 by a hinge, allowing the door 1 to swing open and closed as would a common door 1.

Although the invention has been explained in relation to its preferred embodiment, it is to be understood that many other possible modifications and variations can be made without departing from the spirit and scope of the invention.

What is claimed is:

1. A radio frequency shielding door system, comprising:
a door;
a frame;
a plurality of sealing mechanisms;
the door arranged within the frame;
the plurality of sealing mechanisms arranged between the door and the frame;
the plurality of sealing mechanisms further comprising a first U-channel, a second U-channel, and an inflatable seal;
the second U-channel slidingly engaged within the first U-channel;
the inflatable seal arranged between the first U-channel and the second U-channel; and
the inflatable seal configured to expand when activated.

2. The radio frequency shielding door system of claim 1, further comprising:
the first U-channel comprising a first open end and a first closed end;
the second U-channel comprising a second open end and a second closed end; and
the first closed end and the second closed end positioned opposite one another about the first open end and the second open end.

3. The radio frequency shielding door system of claim 2, further comprising:
the first U-channel further comprising a first flat base and a first pair of prongs;
the second U-channel further comprising a second flat base and a second pair of prongs;
the first flat base being positioned at the first closed end;
the second flat base being positioned at the second closed end;
the first pair of prongs extending away from the first flat base;
the second pair of prongs extending away from the second flat base; and
the first pair of prongs being slidingly engaged with the second pair of prongs.

4. The radio frequency shielding door system of claim 1, further comprising:
at least one pneumatic cylinder;
the at least one pneumatic cylinder operatively engaged with the first U-channel; and
the at least one pneumatic cylinder configured to move the second U-channel relative to the first U-channel.

5. The radio frequency shielding door system of claim 2, further comprising:
the door further comprising a top side, a bottom side, a hinge side, and a latch side;
the frame further comprising a top frame, a hinge frame, a latch frame, and a threshold frame;
the top side being arranged adjacent to the top frame;
the bottom side being arranged adjacent to the threshold frame;
the hinge side being arranged adjacent to the hinge frame;
the latch side being arranged adjacent to the latch frame;
the plurality of sealing mechanisms being arranged within the top side, the bottom side, the hinge frame, and the latch frame; and
the second closed end of the second U-channel of the plurality of sealing mechanisms being arranged adjacent to the top frame, the threshold frame, the hinge side, and the latch side.

6. The radio frequency shielding door system of claim 1, further comprising:
a pneumatic limit switch; and
the pneumatic limit switch being configured to activate and deactivate the plurality of sealing mechanisms.

7. The radio frequency shielding door system of claim 1, further comprising:
the door further comprising a handle; and
the pneumatic limit switch being incorporated into the handle.

8. The radio frequency shielding door system of claim 1, wherein the door, the frame, the first U-channel, and the second U-channel are made of a radio frequency shielding material.

9. A radio frequency shielding door system, comprising:
a plurality of sealing mechanisms;
the plurality of sealing mechanisms further comprising a first U-channel, a second U-channel, and an inflatable seal;
the first U-channel comprising a first open end and a first closed end;
the second U-channel comprising a second open end and a second closed end;
the first closed end and the second closed end positioned opposite one another about the first open end and the second open end;
the second U-channel slidingly engaged within the first U-channel;
the inflatable seal arranged between the first U-channel and the second U-channel;
the inflatable seal configured to expand when activated; and
the door, the frame, the first U-channel, and the second U-channel being made of a radio frequency shielding material.

10. The radio frequency shielding door system of claim 9, further comprising:
the first U-channel further comprising a first flat base and a first pair of prongs;
the second U-channel further comprising a second flat base and a second pair of prongs;
the first flat base being positioned at the first closed end;
the second flat base being positioned at the second closed end;
the first pair of prongs extending away from the first flat base;
the second pair of prongs extending away from the second flat base; and
the first pair of prongs being slidingly engaged with the second pair of prongs.

11. The radio frequency shielding door system of claim 9, further comprising:
at least one pneumatic cylinder;
the at least one pneumatic cylinder operatively engaged with the first U-channel; and
the at least one pneumatic cylinder configured to move the second U-channel relative to the first U-channel.

12. The radio frequency shielding door system of claim 9, further comprising:
a door;
a frame;
the door arranged within the frame; and
the plurality of sealing mechanisms arranged between the door and the frame.

13. The radio frequency shielding door system of claim 12, further comprising:
the door further comprising a top side, a bottom side, a hinge side, and a latch side;
the frame further comprising a top frame, a hinge frame, a latch frame, and a threshold frame;
the top side being arranged adjacent to the top frame;
the bottom side being arranged adjacent to the threshold frame;
the hinge side being arranged adjacent to the hinge frame;
the latch side being arranged adjacent to the latch frame;
the plurality of sealing mechanisms being arranged within the top side, the bottom side, the hinge frame, and the latch frame; and
the second closed end of the second U-channel of the plurality of sealing mechanisms being arranged adjacent to the top frame, the threshold frame, the hinge side, and the latch side.

14. The radio frequency shielding door system of claim 12, further comprising:
a pneumatic limit switch; and
the pneumatic limit switch being configured to activate and deactivate the plurality of sealing mechanisms.

15. The radio frequency shielding door system of claim 14, further comprising:
the door further comprising a handle; and
the pneumatic limit switch being incorporated into the handle.

16. A radio frequency shielding door system, comprising:
a plurality of sealing mechanisms;
the plurality of sealing mechanisms further comprising a first U-channel and a second U-channel;
the first U-channel comprising a first open end and a first closed end;
the second U-channel comprising a second open end and a second closed end;
the first closed end and the second closed end positioned opposite one another about the first open end and the second open end;
the second U-channel slidingly engaged within the first U-channel;
the first U-channel further comprising a first flat base and a first pair of prongs;
the second U-channel further comprising a second flat base and a second pair of prongs;
the first flat base being positioned at the first closed end;
the second flat base being positioned at the second closed end;
the first pair of prongs extending away from the first flat base;
the second pair of prongs extending away from the second flat base; and
the first pair of prongs being slidingly engaged with the second pair of prongs.

17. The radio frequency shielding door system of claim 16, further comprising:
a door;
a frame;
the door being arranged within the frame;
the plurality of sealing mechanisms further comprising an inflatable seal;
the plurality of sealing mechanisms being arranged between the door and the frame;
the inflatable seal arranged between the first U-channel and the second U-channel; and
the inflatable seal configured to expand when activated.

18. The radio frequency shielding door system of claim 16, further comprising:
at least one pneumatic cylinder;
the at least one pneumatic cylinder operatively engaged with the first U-channel; and
the at least one pneumatic cylinder configured to move the second U-channel relative to the first U-channel.

19. The radio frequency shielding door system of claim 17, further comprising:
the door further comprising a top side, a bottom side, a hinge side, and a latch side;
the frame further comprising a top frame, a hinge frame, a latch frame, and a threshold frame;
the top side being arranged adjacent to the top frame;
the bottom side being arranged adjacent to the threshold frame;
the hinge side being arranged adjacent to the hinge frame;
the latch side being arranged adjacent to the latch frame;
the plurality of sealing mechanisms being arranged within the top side, the bottom side, the hinge frame, and the latch frame;
the second closed end of the second U-channel of the plurality of sealing mechanisms being arranged adjacent to the top frame, the threshold frame, the hinge side, and the latch side;
a pneumatic limit switch;
the pneumatic limit switch being configured to activate and deactivate the plurality of sealing mechanisms;
the door further comprising a handle; and
the pneumatic limit switch being incorporated into the handle.

20. The radio frequency shielding door system of claim 16, wherein the door, the frame, the first U-channel, and the second U-channel are made of a radio frequency shielding material.
